(19) United States
(12) Patent Application Publication
(10) Pub. No.: US 2004/0243415 A1
(43) Pub. Date: Dec. 2, 2004

(54) Architecture for a speech input method editor for handheld portable devices

(75) Inventors: Patrick M. Commarford, Delray Beach, FL (US); Mario E. De Armas, Wellington, FL (US); Burn L. Lewis, Ossining, NY (US); James R. Lewis, Delray Beach, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/452,429

(22) Filed: Jun. 2, 2003

(51) Int. Cl. G10L 21/00

(52) U.S. Cl. 704/275

(57) ABSTRACT

A speech input method editor can include a speech toolbar (102) having at least a microphone state/toggle button (104). The speech input method editor can also include a selectable dictation window area (108) used as a temporary dictation target until dictation text is transferred to a target application and a selectable correction window area (112) having at least one among an alternate list (120) for correcting dictated words, an alphabet (114), a spacebar (116), a spell mode reminder (118), or a virtual keyboard (122). The speech input method editor can remain active while using the selectable correction window and while transferring dictation text to the target application. The speech input method editor can further include an alternate input method editor window (112b) used to allow non-speech editing into at least one among the dictation window or to the target application while using the speech input method editor.

### BACKGROUND OF THE INVENTION

1. Technical Field

This invention relates to the field of speech recognition and, more particularly, to a speech recognition input method and interaction with other input methods and editing functions on a portable handheld device.

2. Description of the Related Art

The proliferation of handheld devices in the last few years has caused a surge for creating new non-visual ways of interacting with these small and portable devices. Speech recognition technology is ideal for these kinds of devices. The small form-factor and data-centric use cases create a huge opportunity for any company to facilitate data entry, data access, and overall control of the user's portable applications.

Several different methods of data entry are included with most Portable Device Assistant (PDA) handhelds sold today. But, they all rely on stylus use for tapping onto a virtual mini-keyboard, cursive hand-writing, or block recognizers (such as graffiti). Most hand-recognition technology available in PDAs is inaccurate and cannot be adapted to a specific user's handwriting style. The mini-keyboard method offers better accuracy, but it is cumbersome to use for capturing long and involved notes and thoughts.

Although current speech recognition techniques appear ideally suited for such handheld devices, existing systems are primarily designed to transfer text into applications and fail to allow the transfer of state information from a target field or application via interfaces for an input manager and an input method editor. Furthermore, speech input method editors and other input method editors are not currently designed to manage text flexibly within such editors. Thus, an architecture and method for a speech input method editor for use with handheld portable devices such as personal digital assistants is needed that overcomes the detriments described above.

### SUMMARY OF THE INVENTION

Embodiments in accordance with the invention use speech recognition technology to allow users to enter text data anywhere the user is able to enter data using other Input Method Editors (IMEs). Such embodiments preferably focus on the IME's high-level design, user model, and interactive logic that allows for the leverage of the other (already available) IMEs as alternate input methods into the speech IME.

In a first embodiment of the invention, an architecture for a speech input method editor for handheld portable devices can include a graphical user interface including a dictation area window, a speech input method editor for adding and editing dictation text in the dictation area window, a target application for user selectively receiving the dictation text, and at least an alternate input method editor enabled to edit the dictation text without deactivating the speech input method editor. The speech input method editor can transfer edited dictation text from at least one among the speech input method editor or the alternate input method editor to the target application without deactivating the speech input method editor.

In a second embodiment of the invention, a speech input method editor can include a speech toolbar having at least one among a microphone state/toggle button, an extended feature access button, and a volume level information indicator. The speech input method editor can also include a selectable dictation window area used as a temporary dictation target until dictation text is transferred to a target application and a selectable correction window area comprising at least one among selectable features comprising an alternate list for correcting dictated words, an alphabet, a spacebar, a spell mode reminder, and a virtual keyboard. The speech input method editor can remain active while using the selectable correction window and while transferring dictation text to the target application. The speech input method editor can further include an alternate input method editor window used to allow non-speech editing into at least one among the selectable dictation window or to the target application while using the speech input method editor.

In a third embodiment of the invention, a method of speech input editing for handheld portable devices can include the steps of receiving recognized text, entering the recognized text into a dictation window if the dictation window is visible, and entering the recognized text directly into a target application if the dictation window is hidden. This third embodiment can further include the step of editing the recognized text in the dictation window using a speech input method editor and at least an alternate input method editor that does not deactivate the speech input method editor.

In yet another aspect of the invention, a machine-readable storage can include computer program having a plurality of code sections executable by a machine for causing the machine to perform the steps of receiving recognized text, entering the recognized text into a dictation window if the dictation window is visible, and entering the recognized text directly into a target application if the dictation window is hidden. The computer program can also enable editing of the recognized text in the dictation window using a speech input method editor and at least an alternate input method editor such that editing by the alternate input method editor does not deactivate the speech input method editor.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a hierarchy diagram illustrating the relationship of the input speech method to other components in a handheld device in accordance with the inventive arrangements disclosed herein.

FIG. 2 is a object diagram illustrating a flow among a input method manager object and objects with an input manager according to the present invention.

FIG. 3 is a flow chart illustrating a method of operation of a input method editor in accordance with the present invention.

FIG. 4 illustrates having a speech input method editor and a screen with a hidden dictation window on a personal digital assistant in accordance with the present invention.

FIG. 5 illustrates a screen with a visible dictation window on the personal digital assistant of FIG. 4.

FIG. 6 illustrates a screen with a visible dictation window having an edit field and a correction window area on the personal digital assistant of FIG. 4.

FIG. 7 illustrates a screen with the visible dictation window having no edit field selected and the correction window area on the personal digital assistant of FIG. 4.

FIG. 8 illustrates a screen with a hidden dictation window and a correction window area having a virtual keyboard on the personal digital assistant of FIG. 4.

FIG. 9 illustrates a screen with the visible dictation window having the edit field and the correction window area and an additional or alternative IME on the personal digital assistant of FIG. 4.

FIG. 10 illustrates a screen with the visible dictation window having no edit field and a correction window area in a spell mode showing a spell vocabulary on the personal digital assistant of FIG. 4.

FIG. 11 illustrates a screen with the visible dictation window a correction window area with an alternative list and a virtual keyboard on the personal digital assistant of FIG. 4.

### DETAILED DESCRIPTION OF THE INVENTION

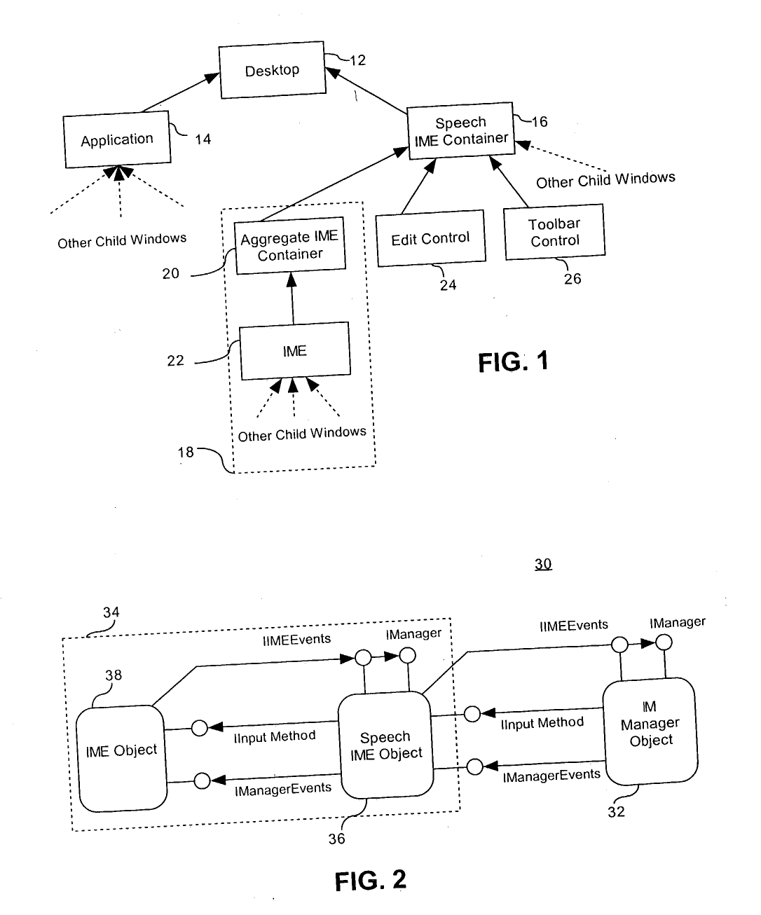

Embodiments in accordance with this invention can implement an alternative speech input method (IM) for a any number of operating systems used for portable handheld devices such as personal digital assistants. In one specific embodiment, the portable device operating system can be Microsoft's PocketPC (WinCE 3.0 and above). The embodiments described herein provide implementation solutions for integrating speech recognition onto handheld devices such as PDAs. The solutions for integrating speech recognition onto handheld devices can be solved on many different levels. Starting at the top, it can be embodied as an IME module that can be selected by the user for activating data entry using speech recognition (dictation). The manner in which the user selected the speech IME can be different between multiple platforms, but usually entails selecting an item (for example “Voice Dictation”) from a list of available IMEs on the device. Referring to FIG. 1, a window hierarchy diagram 10 illustrating an exemplary parent-child relationship among components on a system or architecture in accordance with the present invention is shown. A graphical user interface or desktop 12 can serve as a parent to or have children in the form of a target application 14 (such a word processing program or voice recognition program) and a speech input method editor container 16. The speech input method editor container 16 can serve as a parent to or have children in the form of edit control 24, toolbar control 26 and other child windows. More importantly, the speech input method editor container 16 can serve as a parent to or have a child in the form of a speech input editor 18 that can include an aggregate IME container 20 for a plurality of input method editors 22.

IME modules are managed and actually interact with an Input Method (IM) agent or manager which exposes interfaces to communicate between the IME and the IM manager. Referring to FIG. 2, a COM object diagram 30 is shown illustrating a reference and aggregation relationship among an input manager 34 and an input method editor. In particular, the input manager 32 can interact with an IM manager object 32. In the case of a speech IME, the IM manager object interfaces with a speech IME object 36 which in turn can interface with other IME objects (38) generally. The IM manager 34 in turn can interface directly with target applications and data fields by some OS mechanism (like posting character messages). It is important to remember that IME and IM interfaces (before the present invention) were mainly designed to get text into applications, but not allowed to transfer state information from the target field or application (like selection range, selection text, caret position, mouse events, clipboard events, etc.). Embodiments in accordance with the present invention can ideally transfer state information among interfaces and applications in implementing an effective speech recognition dictation solution to enable dictation clients with a way to allow users to edit/update (correct) the dictated text as to improve and adapt the user's personal voice model for subsequent dictation events. This ability to add and correct new words contributes to the ability of speech recognition technology to achieve recognition accuracies above 90%. Otherwise, users are forced to correct the same mistakes time after time as experienced with block recognizer and transcriber IMEs in PocketPC PDAs.

Being able to correct dictated text using a speech IME was considered a major design requirement in the architectural design herein. In addition, in order to speed up the correction process, the IME can be designed to allow users to select from a short list of alternates (4 items or less preferably) that the speech recognition could return as “best alternates” if a word was not correct initially. These considerations presented more challenges since IMEs were not designed to allow users to manage text WITHIN them, rather only to transfer text to a target data field. Finally, the last and most challenging design issue was related to the ability to correct text generated by an IME using a different IME. The best example of this is the case in which a user speaks a word, which is mis-recognized and needs correcting. In this case, if the user does not find the correct word in the alternate list, then he/she must enter or edit the correct word and somehow apply that towards a correction operation so that his/her personal voice model will adapt correctly for the next time. Here lies the challenge, in order to allow correction of a word, the user should have the ability to enter it without using speech recognition (even though spelling using speech can be available as well). This means having the user to manually switch to another (different) IME module for correcting, which would deactivate the speech IME causing it to loose its visual area with the text that needs correction. This is definitely not an acceptable user scenario and the present invention overcomes this detriment by keeping the speech IME active while other IME modules are used.

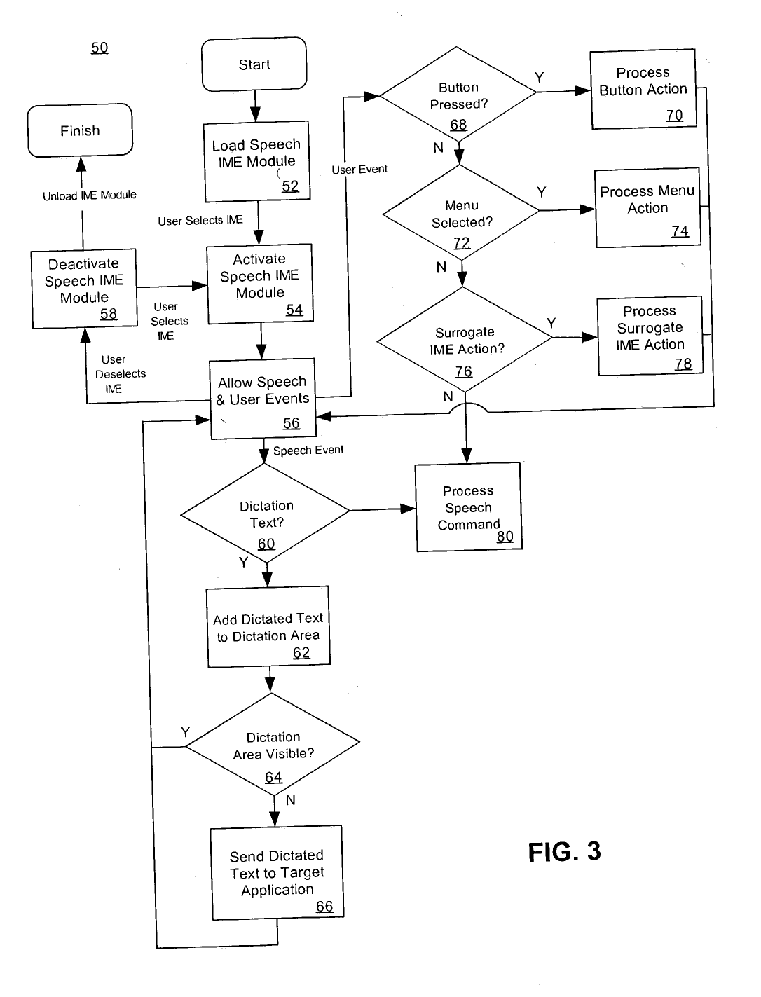

Therefore, the speech IME's design had to overcome these and other challenges in order to be natural and effective in its usage. As already illustrated and discussed with respect to FIGS. 1 and 2, the speech IME's model solves these problems for both logic and user interface design. Additionally, referring to FIG. 3, a flow chart illustrating a method of operation (or usage model) 50 of a input method editor in accordance with the present invention is shown. The method 50 begins by loading a speech IME module on to the handheld portable device at step 52. When the user selects the speech IME as the current IME in the PDA environment of example, then the speech IM module is activated at step 54. There are several ways to do this, but the most common one is to select it from a menu list. Since IMEs are mutually exclusive in their use, any previous IME client area is removed from screen and the speech IME gets a chance to draw its contents.

The IME now allows speech and user events as shown at step 56. Of course, one user event can be the user deselecting the speech IME, in which case the speech IME module is deactivated at step 58. Note, after the user has configured their speech IME working areas to their like, he/she can select a valid target application/field (any app/field that accepts free-form alpha-numeric information) by using the stylus or any other method of selection. Then, the user can begin speaking into the PDA device or perform other user events. If a user event occurs at step 56, then it is determined if a button was pressed at decision block 68, or whether a menu was selected at decision block 72, or whether a surrogate or alternate IME action was invoked at decision block 76. If each of these user events (or other user events as may be designed) do not occur, then the method proceeds to process a speech command at step 80. If a button was pressed at decision block 68, then the button action is processed at step 70 before returning to step 56. If a menu was selected at decision block 72, then the menu action is processed at step 74 before returning to step 56. If a surrogate IME action was invoked at decision block 76, then the surrogate IME action is processed at step 78 before returning to step 56.

If a speech event occurs at step 56, then it is determined if the speech event involves dictation text at decision block 60. If the speech event is not dictation text at decision block 60, then the method proceeds to process a speech command at step 80. If the speech event involve dictation text at decision block 60, then the dictated text is added to the dictation area (of the speech IME) at step 62. If the dictation area is visible at decision block 64, then the method returns to step 56. If the dictation are is hidden at decision block 64, then the dictated text is sent directly to a target application at step 66 before returning to step 56. In summary, steps 60 through 66 involves he speech IME receiving recognized text and performing either one of the following actions: (a) If a dictation window/area is visible, placing recognized text is in its text field (with the ability to correct text, if correction window is visible) or (b) if a dictation window/area is hidden, placing recognized text directly into the target application/field (with no ability to correct text).

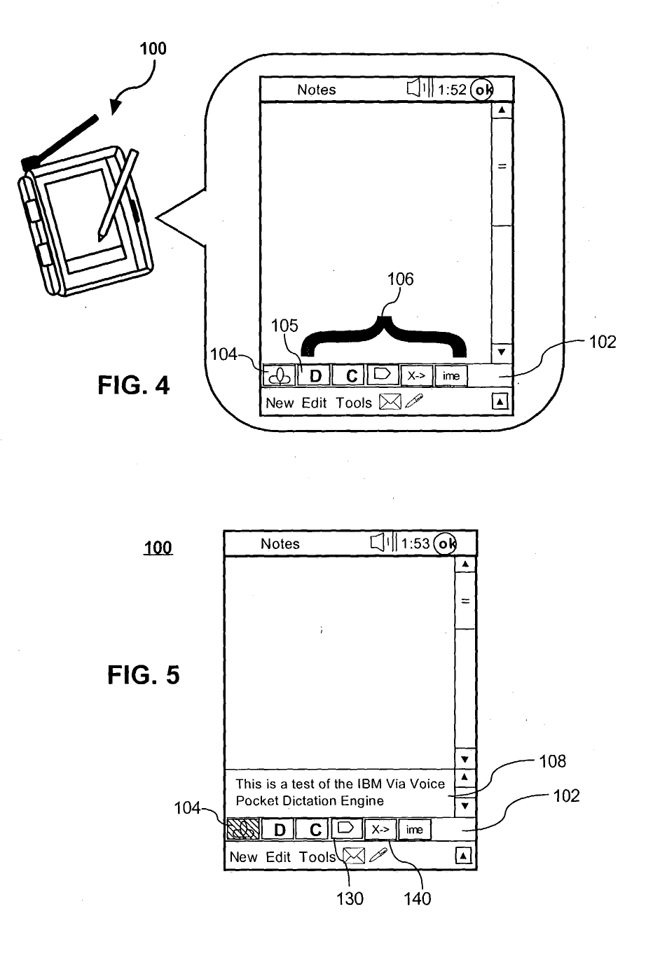

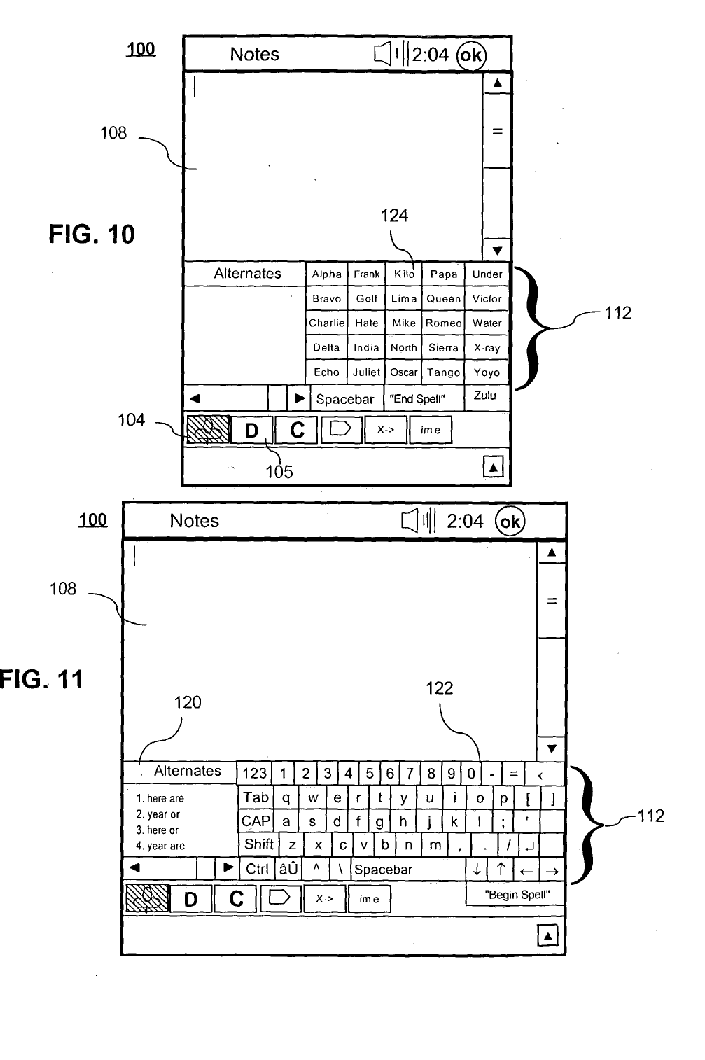

With respect to FIGS. 4-11, a personal digital assistant 100 having a display can illustrate the basic content of a speech IME, which can include:

1. Speech Toolbar 104 (VoiceCenter) which can contain a microphone state/toggle button 104, extended feature access buttons 106 and volume level information. A single button/icon can be used to integrate the microphone state and volume level information if desired.

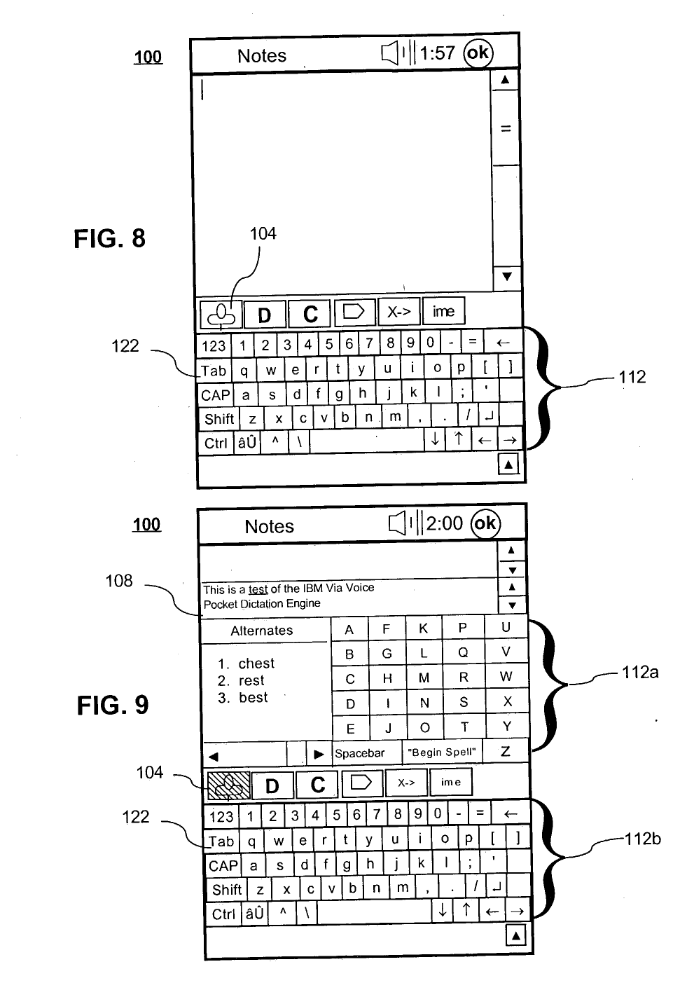

2. Dictation window (area) 108 which can contain an edit field 110 which is used as the direct dictation temporary dictation target until the user transfers the text to a real target application/field. This window/area is optional in nature and can be toggled visible/hidden by the button 104 in the Speech Toolbar. When the dictation window is hidden as shown in FIGS. 4 and 8, all dictated text goes directly into the target application/field without the ability to correct or edit for improvement of user's personal language model (LM) cache.

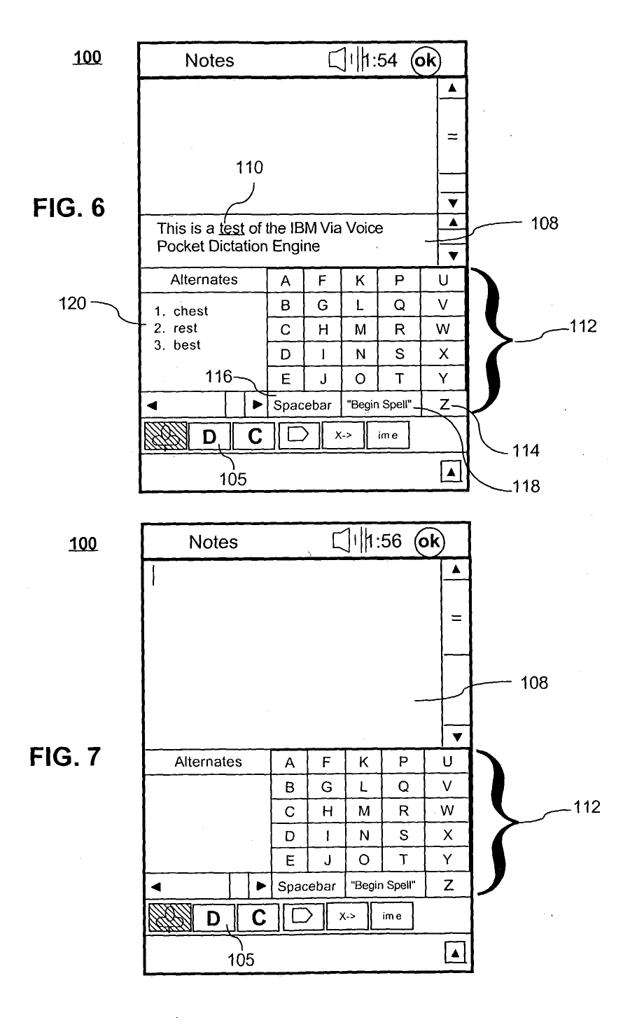

3. Correction window/area 112 can contain the alternate list 120 for correcting dictated words as shown in FIGS. 6, 9 and 11. The correction window/area 112 can also contain the alphabet 114, a spacebar 116, and a spell mode reminder 118. The user can tap each of these areas or can use them as reminders that letters, a spacebar, and spell mode are available through voice commands. The user can replace a word with an alternate from the alternative list 120 by selecting the word(s) to correct from the dictation window and a) tapping the alternate with the stylus or b) saying, “Pick n” (where n is the alternate number). If the user enters spell mode (by tapping or saying, “begin spell”), then the alphabet is replaced with a quick reference to the spell vocabulary 124 (similar to the military alphabet with some changes/additions). The user can now spell the word to be corrected/dictated with this very high-recognition accuracy spell vocabulary 124. The correction window/area 112 is optional and can be toggled visible/hidden by a user button in the Speech Toolbar. The correction window/area 112 can optionally include a mini keyboard 122 embedded in the correction window. This keyboard would display when the user was not in spell mode and would replace the window described above, which contains only the alphabet and spacebar.

4. Alternate/Surrogate IME window/area (112a or 112b as shown in FIG. 9) can contain the alternate IME 112b used to allow non-speech correction/editing into the dictation window or target application while using the speech IME. This feature allows full use of all speech features without compromising the ability to use other existing/installed IMEs in the operating system. This design reduces the amount of user effort required to input information into target applications. By using COM aggregation techniques, the present invention can contain a full-functioning external IME within a speech IME. This hosting technique can be used with a multitude of available IMEs or future IMEs that the user prefers. This alternate IME window/area can be toggled visible/hidden by another user button in the Speech Toolbar 102. The user can pick their preferred alternate IME from an options panel and the speech IME will use that selection every time the user toggles this function.

As the user dictates, the speech IME allows the user to enter spell or number modes, perform correction (if possible), and, if dictating into dictation window/area 108, to transfer dictated text into currently selected application/field. The transfer of text is performed by the speech IME at the user's request. This can be done by a voice command or by pressing a user button in the Speech Toolbar 102. There are two transfer types, which can be accessed at any time. These transfer types are:

(a) Transfer (Simple)—the dictated text is transferred into current application/field and inserted at the current caret position (insertion point) without any special consideration. The dictation window/area field is not affected by this operation and all original text remains after transfer is completed. The icon for this feature can be duplicate pages with an arrow (130). This icon would take advantage of the user's knowledge of the standard copy function (represented by duplicate pages for example) and of the transfer function (represented by a blue arrow for example) from the desktop version of ViaVoice.

(b) Transfer & Clear—the dictated text is transferred as in type (a), but the dictation window/area edit field is cleared and reset for new dictation. This type removes all contents of the dictation area and resets engine context. The icon for this feature can be a pair of scissors with an arrow (140) for example. This icon would take advantage of the user's knowledge of the standard cutclear function (represented by scissors) and of the transfer function from desktop version of ViaVoice. If the user wishes to clear all or some of the contents from the target area, he/she can select the area to be cleared before choosing a transfer option. Another possible transfer type could be:

(c) Transfer (& Clear) & Next Field—this is the same as the previous transfer modes, except the speech IME attempts to move the selection cursor to the next document/field in the input sequence in the currently active application. This allows quicker form-entry scenarios and removes an extra step of having the user manually select the next target field.

The present invention can be realized in hardware, software, or a combination of hardware and software. The present invention can also be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or application in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. An architecture for a speech input method editor for handheld portable devices, comprising:
a graphical user interface including a dictation area window;
a speech input method editor for adding and editing dictation text in the dictation area window;
a target application for user selectively receiving the dictation text; and
at least an alternate input method editor enabled to edit the dictation text without deactivating the speech input method editor.

2. The architecture of claim 1, wherein the speech input method editor transfers edited dictation text from at least one among the speech input method editor and the alternate input method editor to the target application without deactivating the speech input method editor.

3. The architecture of claim 1, wherein the speech input method editor further comprises a speech input method editor window that remains visible when the alternate input method editor edits the dictation text.

4. The architecture of claim 1, wherein the architecture further comprises an input method manager that interacts with the speech input method editor.

5. The architecture of claim 4, wherein the input method manager interacts with target applications and data fields.

6. The architecture of claim 5, wherein the input method manager and the speech input method editor transfer state information from at least one among a target field and a target application to the target application.

7. The architecture of claim 6, wherein the state information is selected from the group of selection range, selection text, caret position, mouse events, and clipboard events.

8. The architecture of claim 6, wherein the speech input method editor enables a user of the handheld portable devices to manage text within the speech input method editor.

9. The architecture of claim 6, wherein the alternate input method editor is enabled to edit dictation text generated by the speech input method editor.

10. A speech input method editor, comprises:
a speech toolbar having at least one among a microphone state/toggle button, an extended feature access button, and a volume level information indicator;
a selectable dictation window area used as a temporary dictation target until dictation text is transferred to a target application; and
a selectable correction window area comprising at least one among selectable features comprising an alternate list for correcting dictated words, an alphabet, a spacebar, a spell mode reminder, and a virtual keyboard, wherein the speech input method editor remains active while using the selectable correction window and transferring dictation text to the target application.

11. The speech input method editor of claim 10, wherein the speech input method editor further comprises an alternate input method editor window used to allow non-speech editing into at least one among the selectable dictation window or to the target application while using the speech input method editor.

12. The speech input method editor of claim 10, wherein dictation text is automatically transferred to the target application when the selectable dictation window is in an unselected mode.

13. The speech input method editor of claim 10, wherein the selectable correction window area is toggled between hidden and visible.

14. The speech input method editor of claim 11, wherein the speech input method editor transfers edited dictation text from at least one among the speech input method editor and the alternate input method editor window to the target application without deactivating the speech input method editor.

15. The speech input method editor of claim 10, wherein the speech input method editor is an application within a handheld personal digital assistant.

16. A method of speech input editing for handheld portable devices, comprising the steps of:
receiving recognized text;
if a dictation window is visible, entering the recognized text into the dictation window; and
if a dictation window is hidden, entering the recognized text directly into a target application.

17. The method of claim 16, wherein the method further comprises the step of editing the recognized text in the dictation window using a speech input method editor and at least an alternate input method editor, wherein editing by the alternate input method editor does not deactivate the speech input method editor.

18. The method of claim 17, wherein the step of editing with at least an alternate input method editor further comprises activating an associated window.

19. The method of claim 17, wherein the method further comprises the step of transferring edited recognized text to the target application using the speech input method editor.

20. The method of claim 19, wherein the step of transferring comprises the step selected from 1) inserting the edited recognized text to an insertion point in the target application; 2) inserting the edited recognized text to the insertion point in the target application and clearing the dictation window; 3) selecting an area to be cleared in the target application and then inserting the edited recognized text to the insertion point in the target application; and 4) inserting the edited recognized text to the insertion point in the target application, clearing the dictation window, and moving a selection cursor to a next document or field in an input sequence in the target application.

21. A machine-readable storage, having stored thereon a computer program having a plurality of code sections executable by a machine for causing the machine to perform the steps of:
receive recognized text;
if a dictation window is visible, enter the recognized text into the dictation window and enable editing of the recognized text in the dictation window using a speech input method editor and at least an alternate input method editor, wherein editing by the alternate input method editor does not deactivate the speech input method editor; and
if a dictation window is hidden, enter the recognized text directly into a target application.
